(19) United States
(12) Patent Application Publication
(10) Pub. No.: US 2009/0015111 A1
(43) Pub. Date: Jan. 15, 2009

(54) MOTOR ASSEMBLY FOR CEILING FAN

(76) Inventor: Chien Hsun CHEN, Taichung (TW)

Correspondence Address: SINORICA, LLC, 528 FALLSGROVE DRIVE, ROCKVILLE, MD, 20850, US

(21) Appl. No.: 11/829,894

(22) Filed: Jul. 28, 2007

(30) Foreign Application Priority Data
Jul. 13, 2007 (TW) 096211389

(51) Int. Cl. H02K 5/04; H02K 11/00

(52) U.S. Cl. 310/68 B; 310/73; 310/68 R; 310/89; 416/244 R

(57) ABSTRACT

A motor assembly for ceiling fans includes a top cover having a plurality of protrusions extending from a top thereof, a bottom cover and a ring-shaped member connected between the top cover and the bottom cover so as to form a case. A shaft rotatably extends through the top cover and the bottom cover. A stator is fixed to the shaft and located in the case, and a permanent magnet is fixed to an inner periphery of the ring-shaped member. A light detection device is connected to the frame and includes a light detection member. A circuit board is located in the light detection device. The protrusions pass through the light detection member to block a light beam emitted from the light detection member to activate the light detection member to send a signal to the circuit board to count the revolution of the shaft.

### FIELD OF THE INVENTION

The present invention relates to a DC motor for a ceiling fan and includes light detection members to survey rotation of the motor.

### BACKGROUND OF THE INVENTION

A conventional motor assembly for ceiling fans is shown in FIG. 7 and generally includes a case composed of a top cover 70 and a bottom cover 71 which is connected with the top cover 70 so as to receive a permanent magnet 700 in the case. A shaft 72 rotatably extends through the top cover 70 and the bottom cover 71 and a stator 73 is fixed to the shaft 72. The stator 73 is provided electromagnetic force so as to cause changes of the magnetic field relative to the permanent magnet 700 to rotate the shaft 72. However, the conventional motor assembly can only be operated between on and off, and this single operation mold cannot meet requirements of the latest ceiling fans. Besides, once the motor assembly is stopped, it can only be re-started from the first stage of revolution of the ceiling fans. The user cannot re-start the ceiling fan from the second stage of revolution directly.

The present invention intends to provide a motor assembly which includes a light detection device connected to the shaft and the top cover includes protrusions which block the light emitted from the light detection device so as to survey the revolution of the motor and an information of revolution is sent to the circuit board so as to activate the motor assembly when re-started.

### SUMMARY OF THE INVENTION

The present invention relates to a motor assembly which comprises a top cover having a plurality of protrusions extending from a top thereof and a bottom cover is connected to the top cover with a ring-shaped member connected between the top cover and the bottom cover so as to form a case. A shaft rotatably extends through the top cover and the bottom cover, a stator is fixed to the shaft and located in the case. A permanent magnet is fixed to an inner periphery of the ring-shaped member. A frame is connected to the shaft and located above the top cover, a light detection device is connected to the frame and includes a light detection member which is located at an underside of the light detection device. The protrusions pass through the light detection member to block a light beam emitted from the light detection member so as to count the number of revolution of the shaft and the information of the revolutions is sent to a circuit board is located in the light detection device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the motor assembly of the present invention;

FIG. 2 is an exploded view to show the motor assembly of the present invention;

FIG. 3 is a cross sectional view to show the motor assembly of the present invention;

FIG. 4 is a cross sectional view to show that the shaft of the motor assembly of the present invention rotates and the protrusions pass through the light detection members;

FIG. 5 is a cross sectional view to show another embodiment of the way that the protrusions are fixed to the top cover;

FIG. 6 is a cross sectional view to show yet another embodiment of the way that the protrusions are fixed to the top cover, and

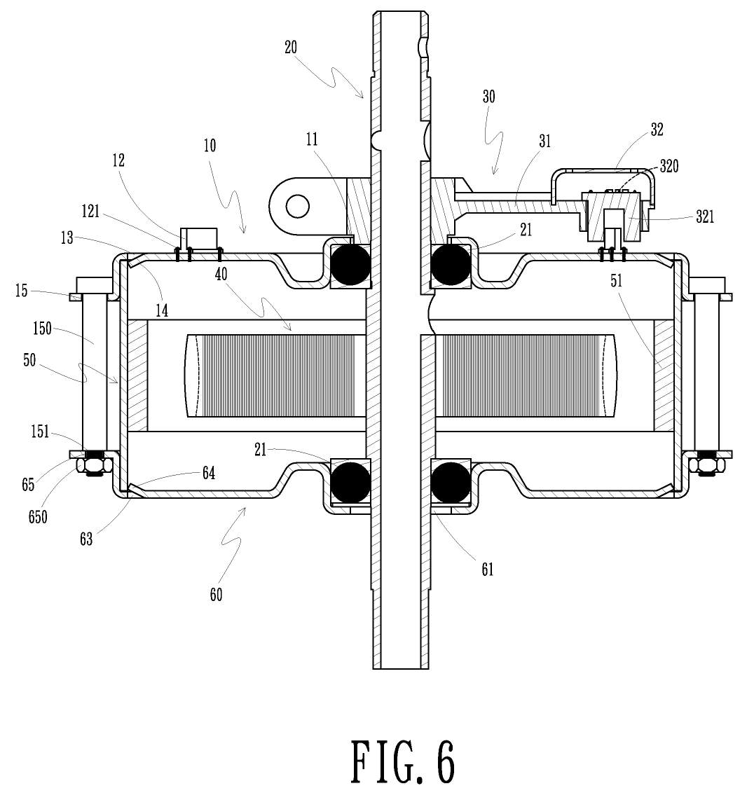

FIG. 7 is a cross sectional view to show the conventional motor assembly.

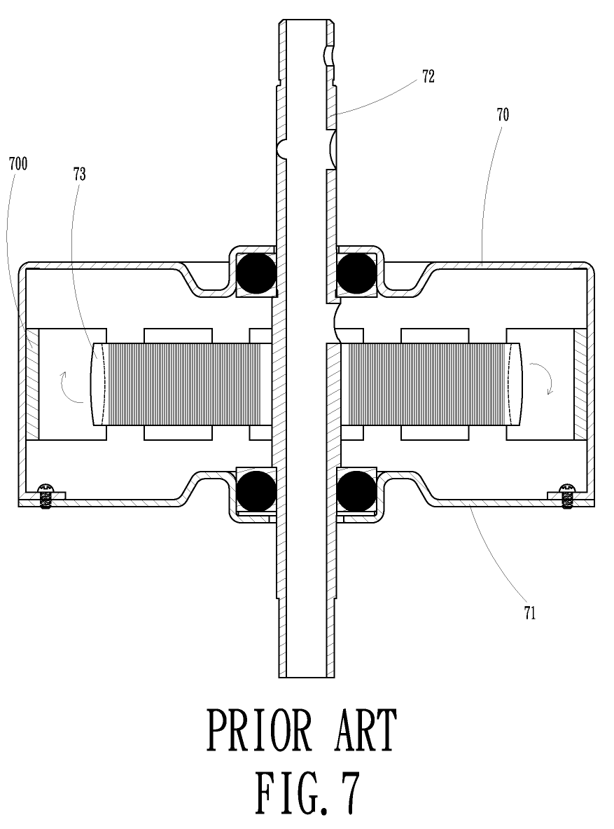

### DETAILED DESCRIPTION OF THE PREFERRED EMBODIMENT

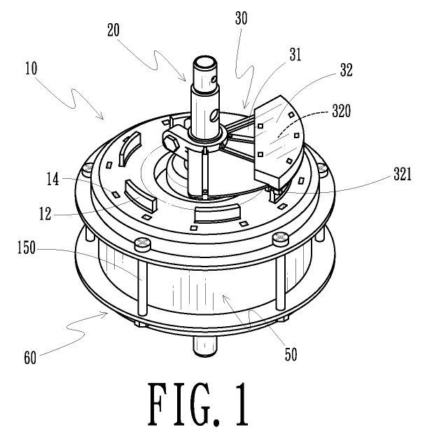

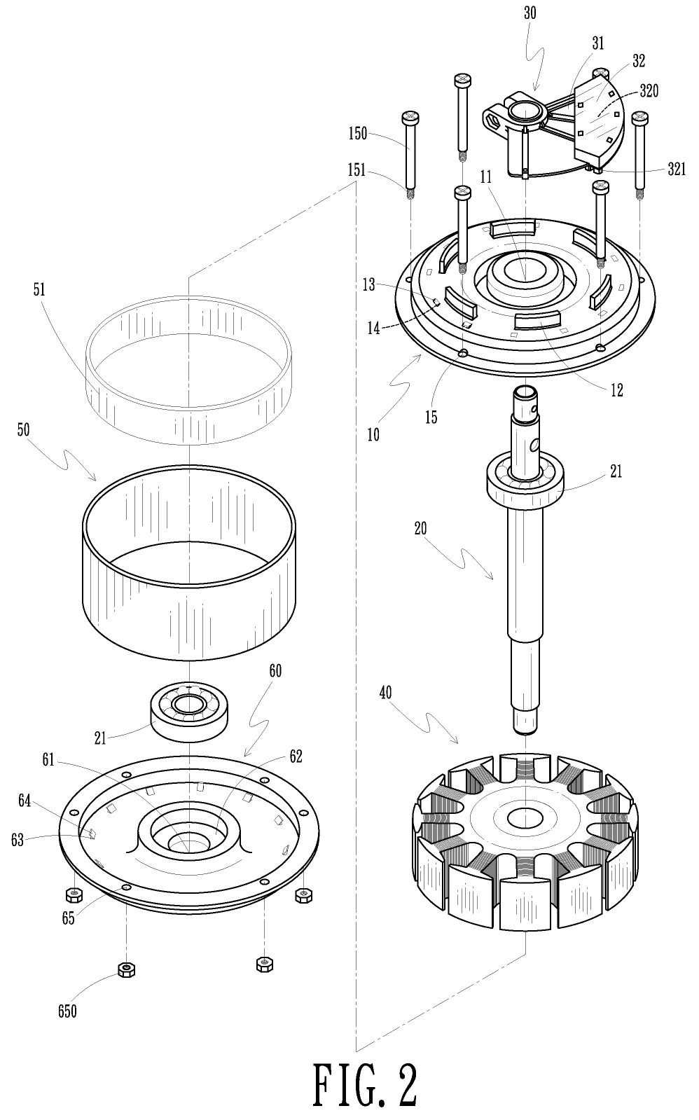

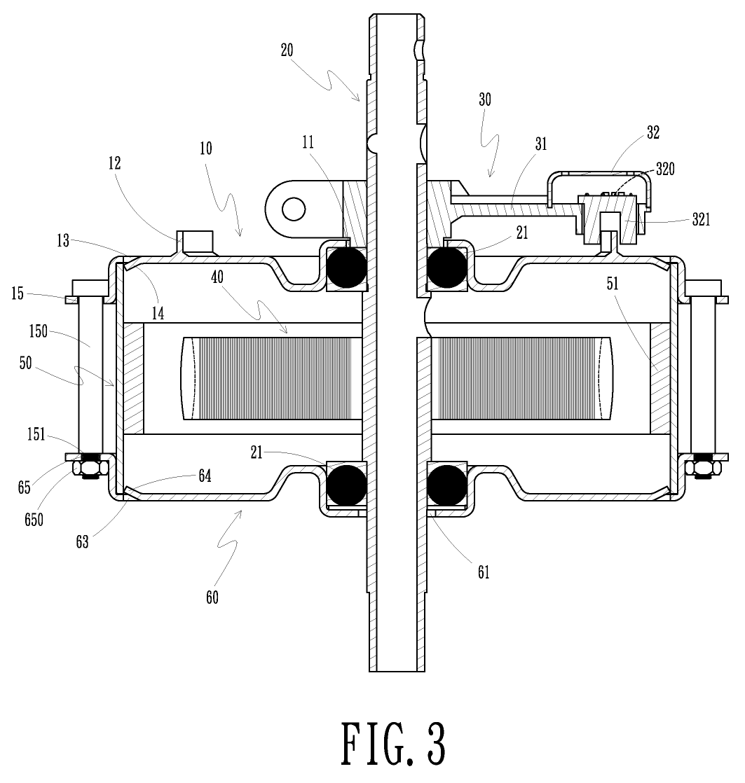

Referring to FIGS. 1 to 3, the motor assembly for ceiling fans of the present invention comprises a top cover 10 having a plurality of protrusions 12 integrally extending from a top thereof and a plurality of first dents 13 are formed on the top of the top cover 10 so as to form first stubs 14 extending from an underside of the top cover 10. A bottom cover 60 is connected to the top cover 10 with a ring-shaped member 50 connected between the top cover 10 and the bottom cover 60 so as to form a case. A permanent magnet 51 is fixedly connected to an inner periphery of the ring-shaped member 50. The bottom cover 60 includes a plurality of second dents 63 defined in an underside thereof so as to form a plurality of second stubs 64 extending from a top of the bottom cover 60. The first and second stubs 14, 64 are in contact with an inside of the ring-shaped member 50 so as to position the ring-shaped member 50.

The top cover 10 includes a plurality of first holes 15 defined through a peripheral flange thereof and the bottom cover 60 includes second holes 65 defined through a peripheral flange thereof. Bolts 150 extend through the first and second holes 15, 65 and are connected with nuts 650 by respective threaded sections 151 of the bolts 150 to firmly connect the top cover 10, the bottom cover 60 and the ring-shaped member 50.

The top cover 10 includes a first bowl-shaped portion on the top thereof and a first central hole 11 is defined through the first bowl-shaped portion. A first recessed area is defined by the first bowl-shaped portion in the underside of the top cover 10. The bottom cover 60 includes a second bowl-shaped portion and a second central hole 61 defined through the second bowl-shaped portion. A second recessed area 62 is defined by the second bowl-shaped portion in the top of the bottom cover 60. Two bearings 21 are respectively located in the first and second recessed areas and a shaft 20 rotatably extending through two bearings 21, the top cover 10 and the bottom cover 60.

A stator 40 is fixed to the shaft 20 and located in the case and located corresponding to the permanent magnet 51 fixed to the ring-shaped member 50.

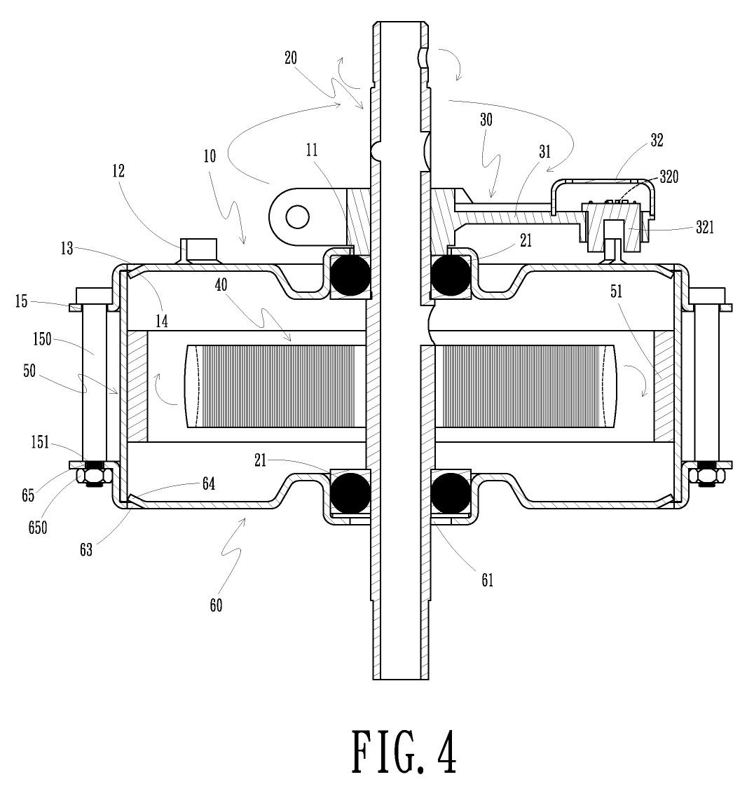

A frame 30 is connected to the shaft 20 and located above the top cover 10. The frame 30 includes a fan-shaped support member 31 and a light detection device 32 is connected to the fan-shaped support member 31 on the frame 30. The light detection device 32 includes a light detection member 321 located at an underside of the light detection device 32 and a circuit board 320 is located in the light detection device 32. Further referring to FIG. 4, the light detection member 321 is an inverted U-shaped member so that when the shaft 20 rotates, the protrusions 12 pass through the light detection member 321 to block a light beam emitted from the light detection member 321 so as to count the number of revolution of the shaft 20. The information of the revolution of the shaft 20 is sent to the circuit board 320 and the control circuit of the circuit board 320 is electrically connected with the switch or the like so that the user can demand the number of revolution of the shaft 20 whenever re-starting the ceiling fan.

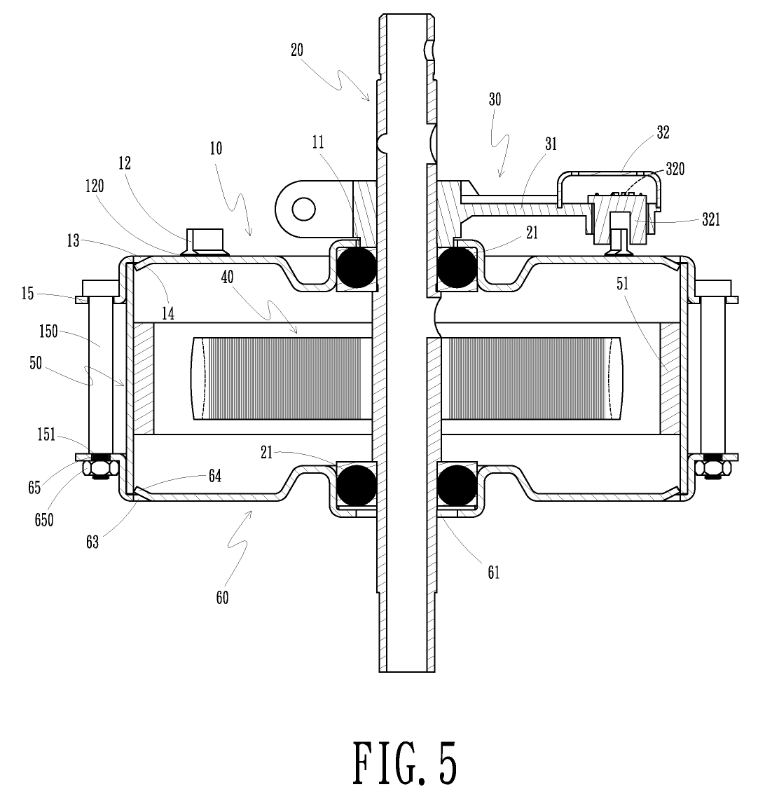

The protrusions 12 can be connected to the top cover 10 by glue 120 as shown in FIG. 5 or the protrusions 12 can be connected to the top cover 10 by rivets 121 as shown in FIG. 5.

While we have shown and described the embodiment in accordance with the present invention, it should be clear to those skilled in the art that further embodiments may be made without departing from the scope of the present invention.

What is claimed is:

1. A motor assembly comprising:
a top cover having a plurality of protrusions extending from a top thereof;
a bottom cover connected to the top cover with a ring-shaped member connected between the top cover and the bottom cover so as to form a case;
a shaft rotatably extending through the top cover and the bottom cover, a stator fixed to the shaft and located in the case, a permanent magnet fixed to an inner periphery of the ring-shaped member, and
a frame connected to the shaft and located above the top cover, a light detection device connected to the frame and including a light detection member located at an underside of the light detection device, a circuit board located in the light detection device, the protrusions passing through the light detection member to block a light beam emitted from the light detection member.

2. The assembly as claimed in claim 1, wherein the top cover includes a plurality of first holes defined through a peripheral flange thereof and the bottom cover includes second holes defined through a peripheral flange thereof, bolts extend through the first and second holes and connected with nuts.

3. The assembly as claimed in claim 1, wherein the top cover includes a plurality of first stubs extending from an underside thereof and the bottom cover includes a plurality of second stubs extending from a top thereof, the first and second stubs are in contact with an inside of the ring-shaped member.

4. The assembly as claimed in claim 1, wherein the protrusions are integrally connected to the top cover.

5. The assembly as claimed in claim 1, wherein the protrusions are connected to the top cover by glue.

6. The assembly as claimed in claim 1, wherein the protrusions are connected to the top cover by rivets.
